(19) United States
(12) Patent Application Publication
(10) Pub. No.: US 2005/0013911 A1
(43) Pub. Date: Jan. 20, 2005

(54) Process for rendering nutritional and industrial properties in seeds easily assimilable

(76) Inventors: Peter Francis Berchtold, Randburg (ZA); Andries Wilhelm Johannes Weideman, Croydon (ZA)

Correspondence Address: BANNER & WITCOFF, 1001 G STREET N W, SUITE 1100, WASHINGTON, DC, 20001, US

(21) Appl. No.: 10/495,334

(22) PCT Filed: Nov. 12, 2002
(86) PCT No.: PCT/IB02/04709

(30) Foreign Application Priority Data
Nov. 12, 2001 (ZA) 2001/3837

(51) Int. Cl. A23B 4/03

(52) U.S. Cl. 426/465

(57) ABSTRACT

The invention provides a process for rendering various nutritional and industrial properties in certain seeds of the plant families amaranthaceae, leguminoceae, cruciferum, chenopodiaceae and brassica easily assimilable and/or suitable for industrial use, the process including the steps of continuously heating seeds to a predetermined temperature, stabilising seeds at the temperature and then allowing the seeds to cool to ambient conditions.

### INTRODUCTION TO THE INVENTION

This invention relates to the processing of food or industrial products and more particularly to the processing of food or industrial products out of certain of the seeds of the plant families amaranthaceae, leguminoceae, cruciferum, chenopodiaceae and brassica.

This invention also provides for the preparation of composite food or industrial products by combining, integrating or otherwise embodying the processed seeds together with other substances or products.

### BACKGROUND OF THE INVENTION

The seeds of the members of the amaranthaceae, leguminoceae, cruciferum, chenopodiaceae and brassica families, and particularly soya beans of the plant genus glycine, are rich in nutrients and have properties which make them suitable for industrial use. Assimilable proteins and other macro and micro nutrients have been obtained by processing these seeds and certain of these processing procedures are well known and have been used, particularly in Asia, for many years.

The processing of seeds of the types referred to is undertaken to render the food palatable, digestible and, as far as possible, to release their nutrient content in an easily assimilable form while maintaining anti-nutritive substances to as low a limit as possible. The nutritional content of the food obtained has been studied and is well known to those skilled in the art. Seeds of the types referred to rank high on listings of nutrient-rich foods or industrial raw materials, and processing in different ways look to different protein combinations, nutrients and potentials being available for nutritional and industrial use.

### OBJECT OF THE INVENTION

It is the object of the present invention to provide a process for certain of the seeds of the plant families amaranthaceae, leguminoceae, cruciferum, chenopodiaceae and brassica which will render various properties in these seeds nutritionally assimilable and/or suitable for industrial use.

### SUMMARY OF THE INVENTION

In accordance with this invention there is provided a process for rendering various nutritional and industrial properties in certain seeds of the plant families amaranthaceae, leguminoceae, cruciferum, chenopodiaceae and brassica easily assimilable and/or suitable for industrial use comprising continuously heating seeds to a predetermined temperature, stabilising seeds at the temperature and then allowing the seeds to cool to ambient conditions.

Further features of the invention provide for the seeds to be whole or fragmented; and for cooling to be by complete or partial removal of heat from the seeds or by induction with cooling apparatus.

Still further features of the invention provide for the seeds of the plant family leguminoceae to be heated to a temperature of up to 210° C. within 12 minutes and to be stabilised at the temperature for a period of up to 20 minutes prior to cooling.

Yet further features of the invention provide for the seeds of the plant families amaranthaceae, cruciferum, chenopodiaceae and brassica to be heated to a temperature of up to 120° C. within a period of 10 minutes and to be stabilised at the temperature for a period of up to 15 minutes prior to cooling.

Further features of the invention provide for light, or light filtered to control the emission of radiation or irradiation, to be applied to the seeds during the process.

Still further features of the invention provide for the seeds to be heated in apparatus at least partially filled with nitrogen; and for the apparatus to be operated at any pressure relative to atmospheric pressure.

Yet further features of the invention provide for the seeds to be reduced in size if required by a market or on-process at any stage during or subsequent to processing by splitting, milling or in any other way to any required size for consumption either immediately or following intermediate storage or holding.

The invention also provides for the use of processed seeds as defined above in the preparation of a food or industrial product.

Further features of the invention provide for use of the processed seeds in the preparation of the food or industrial product to be by way of baking, blending, supplementing, beneficiation or integration; and for such use to occur immediately after processing or after a period of storage.

### DESCRIPTION OF PREFERRED EMBODIMENTS OF THE INVENTION

Two examples of a process according to the invention are described below by way of example only.

### EXAMPLE 1

According to this example, whole dried seeds of the plant family leguminoceae are introduced into a vessel which is pre-heated to a temperature of 160° C. The seeds are allowed to stabilise at this temperature for a period of 12 minutes whereafter they are allowed to cool to ambient temperature.

Hereafter, the processed seeds are available for use.

### EXAMPLE 2

According to this example, whole seeds of the plant family amaranthaceae, cruciferum, chenopodiaceae or brassica are introduced into a vessel which is partially filled with nitrogen gas. The seeds are then heated to a maximum temperature of 120° C. within a period of 10 minutes and allowed to stabilise at the temperature for up to 15 minutes. Hereafter the seeds are allowed to cool to ambient temperature.

In respect of both Examples 1 and 2 it has also been found that light can be applied to the seeds at any stage during the process. The light is preferably filtered to control the emission of radiation or irradiation, including infrared radiation and ultraviolet irradiation. Light has been found to reduce the original presence of phenols and to prevent the formation of new phenols during the process as phenols are light sensitive. The action of light also prevents certain molecular structures from going into a reverse action due to the light-sensitivity of such molecules during certain stages of the process. The action of light also influences the activity of various vitamins in relation to the formation of bacterias during the process. The light can be applied intermittently or continuously for any suitable period of time.

Furthermore, processing can take place at any pressure relative to atmospheric pressure and the seeds could be processed in a fragmented condition

Cooling of the seeds can be achieved by either the complete or partial removal of heat or by induction using cooling apparatus. Also, the seeds could be whole or fragmented during processing.

With seeds of the plant family leguminoceae it has been found that a maximum temperature of 210° C. can be used in the process, that heating to the selected temperature should occur within a maximum of 12 minutes and that stabilisation at the temperature should not be longer than 20 minutes.

The temperature and times of heating may vary widely dependent upon raw material and environmental conditions and/or the seed genus or genera under process. It is envisaged that conditions will have to be closely monitored to ensure that the required results are being achieved and that such conditions may vary from batch to batch. Heating may be affected by micro or other high or low-frequency waves, radiation, induction or by the application of dry steam, or any combination of these, provided the heating is dry heating. In the context of this invention, the tern “dry heating” is to be construed to mean at any moisture load as results from the interaction of prevailing atmospheric conditions and/or process and/or product characteristics, but excluding any deliberate artificial input of moisture.

The above examples are thus not be considered as limiting the invention and could include a combination of the above processes provided that the seeds are heated to a predetermined temperature, stabilised at the temperature and thereafter cooled to ambient temperature.

The process utilises the seed's own inherent characteristics to effect changes in structure under heating and uses the application of light and/or an artificially induced presence of nitrogen as the only supplementary mediums. No substances otherwise are added to, applied or detracted from the seeds.

Processing of the seeds as described denatures certain molecular structures from their original state, resulting in, but not limited to, the rearranging, modifying, combining, reducing, and/or formation of structures which, inter alia, include structures described as amino acids, proteins, vitamins, enzymes, bacteria, viruses, minerals and/or fatty constituents.

The process results in, but is not limited to, the modification of certain amino acids and/or amino acid chains by the activation, control and/or modification of certain enzymes, bacteria and/or viruses naturally present, by, but not limited to, esterification, fermentation and/or monomer/dimer reaction.

The denaturing of hydrocarbon bondings results in certain conversions to peptide bondings by, interalia, monomer/dimer actions and/or chain reactions and the rearranging of certain bonded structures and/or the transfer of certain chemical structures and/or the modification of certain atomic structures, in part or whole. The number of reactions and potential reactions which occur are in fact too numerous to enumerate and some are not fully understood.

The formation of trivalent bondings of peptides will set complete protein molecules free (that is, produce unbonded forms). Certain amino add structures will also be modified to set-free complete protein molecules and/or molecular structures of “essential” and “non-essential” amino acid bases and other potentials, thereby increasing nutritional values and/or enhancing the suitability for nutritional or industrial applications.

Trypsin inhibitors are controlled by, but not limited to specific time, temperature and/or environmental conditions, and certain light-sensitive constituents, which include certain anti-nutritive factors, are reduced and/or modified by the strategic application of light, heat and/or environmental conditions prior, during or subsequent to the process. As indicated above, the process conditions used will depend on the characteristics of the seeds used and the prevailing environmental conditions.

Certain undesirable bacteria, moulds and yeasts are controlled and certain viruses, enzymes and bacteria naturally present are controlled and/or modified to provide certain anti-bacterial and/or antibiotic characteristics. It is difficult to specifically quantify such actions due to the enormous number of potential reactions and because some of the actions are not fully understood.

The products derived from the above process whether whole or in fractions may be composite food and industrial substances obtained at economical cost, to be used either without further beneficiation, or in combination with any other product, manufacture, substance or raw material.

Additionally, certain constituents may be isolated from the product to be used either without further beneficiation, or in combination with any other product, manufacture, substance or raw material.

The process will however preferably be controlled to yield a product having a percentage protein yield in the range of up to 45 per cent, dependent upon the seed genus or genera under process.

The process is monitored to ensure that micro-organism growth after primary processing falls within the following average specifications:

| | | |
|---|---|---|
| Getrimide Agar | after 72 hours | no growth |
| Baird-Parker Agar | after 72 hours | no growth |
| Vogel & Johnsons Agar | after 72 hours | no growth |

Also, the process is monitored to ensure that colony formation will be controlled to a total number of:

| | |
|---|---|
| Aerobes | Max. 1 × 10 to the power of 3 |
| | Casoy Agar - 300/g after 5-7 days |
| Moulds | Max. 1 × 10 to the power of 2 |
| | SABS Agar - 45/g after 5-7 days |
| Yeasts | Max. 1 × 10 to the power of 2 |
| | SABS Agar - 25/g after 5-7 days |

The process conditions may thus be adjusted from time to time to ensure that the above requirements are met.

It is further envisaged that only raw seeds will be treated and that such seeds will be treated in an unprocessed state. “Unprocessed” in this sense means that the seeds will not have had their physical structure altered.

According to the invention the processed seed can be used in the preparation of a food or industrial product, whether in itself or in combination with any other raw material, manufacture or product. Such products may include other substances or raw materials and use could be by way of any one or more of the following methods either immediately after processing or after a period of storage:
Baking; which term shall include toasting, roasting and grilling;
Blending; which term shall include combining, infusion, suffusion, transfusion, inclusion, coalescence, mixture, admixture and amalgamation;
Supplementing; which term shall include fortifying, complement, addition and substitution;
Benefication; which term shall include sacrificial; and
Integration; which term shall include embodiment.

The seeds processes according to the invention can be used for purposes of nutrition or to combat malnutritional conditions brought about by nutritional deficiencies irrespective of causation, as well as in industrial processes.

1. A process for rendering various nutritional and industrial properties in seeds of the plant families amaranthaceae, leguminoceae, cruciferum, chenopodiaceae and brassica easily assimilable and/or suitable for industrial use, characterized in that the process comprises continuously heating seeds to a predetermined temperature, stabilizing seeds at the temperature and then allowing the seeds to cool to ambient conditions.

2. A process as claimed in claim 1 characterized in that the seeds are whole or fragmented.

3. A process as claimed in claim 1 characterized in that the seeds are cooled by way of complete or partial removal of heat from the seeds.

4. A process as claimed in claim 1 characterized in that the seeds are cooled by induction with cooling apparatus.

5. A process as claimed in claim 1 characterized in that seeds of the plant family leguminoceae are heated to a predetermined temperature of up to 210° C.

6. A process as claimed in claim 5 characterized in that the seeds are heated to the predetermined temperature within 12 minutes.

7. A process as claimed in claim 5 characterized in that the seeds are stabilized at the predetermined temperature for a period of up to 20 minutes prior to cooling.

8. A process as claimed in claim 1 characterized in that seeds of the plant families amaranthaceae, cruciferum, chenopodiaceae and brassica are heated to a predetermined temperature of up to 120° C.

9. A process as claimed in claim 8 characterized in that the seeds are heated to the predetermined temperature within 10 minutes.

10. A process as claimed in claim 8 characterized in that the seeds are stabilized at the predetermined temperature for a period of up to 15 minutes prior to cooling.

11. A process as claimed in claim 1 characterized in that light is applied to the seeds during the process.

12. A process as claimed in claim 11 characterized in that the light is filtered to control emission of either or both of radiation or irradiation.

13. A process as claimed in claim 1 characterized in that the seeds are heated in an apparatus at least partially filled with nitrogen.

14. A process as claimed in claim 1 characterized in that the seeds are heated in an apparatus operated at a pressure above or below atmospheric pressure.

15. A process as claimed in claim 1 characterized in that the seeds are reduced in size during or subsequent to heating.

16. A process as claimed in claim 1 characterized in that the seeds are raw.

17. A process as claimed in claim 1 characterized in that the seeds are unprocessed.

18. Use of seeds processed in accordance with claim 1 characterized in that it is in the preparation of a food or industrial product.

19. Use of the seeds as claimed in claim 18 characterized in that the food or industrial product is prepared by any one or more of baking, blending, supplementing, beneficiation and integration.

20. (cancelled)
